(19) United States
(12) Patent Application Publication
(10) Pub. No.: US 2008/0182600 A1
(43) Pub. Date: Jul. 31, 2008

(54) METHOD OF MESSAGES TRANSMISSION AND COMPUTER-READABLE MEDIUM THEREOF

(75) Inventors: Anku Jain, Gurgoan (IN); Amit Kumar, Meerut (IN)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: PIXTEL MEDIA TECHNOLOGY (P) LTD., Noida (U.P.) (IN)

(21) Appl. No.: 11/770,780

(22) Filed: Jun. 29, 2007

(30) Foreign Application Priority Data
Jan. 31, 2007 (IN) 201/DEL/2007

(51) Int. Cl. H04Q 7/20

(52) U.S. Cl. 455/466

(57) ABSTRACT

A efficient and quick method and a computer-readable medium of sending messages. The method of sending a message comprises providing a shortcut with a corresponding message and recipient address, receiving a shortcut entry, determining whether the shortcut entry matches the shortcut, and sending the corresponding message to the corresponding recipient address when the shortcut entry matches the shortcut.

### CROSS REFERENCE

This application claims the benefit of India provisional application Ser. No. 201/DEL/2007 filed on Jan. 31, 2007, the subject matter of which is incorporated herein by reference.

### BACKGROUND OF THE INVENTION

1. Field of the Invention

The invention relates to telecommunication and in particular to a method of SMS and MMS transmission in a telecommunication system.

2. Description of the Related Art

Short Message Service (SMS) provides transmission of data over protocols such as GSM, Code Division Multiple Access (CDMA), and Time Division Multiple Access (TDMA), available on most digital mobile phones, other mobile devices (e.g. a Pocket PC, PDA, or even desktop computers) and some fixed phones, permitting the sending of short messages therebetween. SMS is widely used for delivering digital content such as news alerts, financial information, logos and ringtones. Such messages are also known as premium-rated short messages (PSMS). Another category of Messages is MMS [Multi Media Message Service] where user can send Audio, Video, and Image objects along with rich text object.

Mobile handset users frequently send messages with predefined text to predefined numbers. These messages can contain predefined information to be sent to a fixed destination, or messages that need to be sent periodically to get updated information such as sports scores, status of transport ticket, updated flight time, or periodic messages to send some fixed information, like sending Message while leaving office or others.

In a conventional telecommunication framework, Messaging tasks require browsing through a menu screen to a Write Message command and then inputting text and entering a recipient's number. Alternatively, users can save the text in an outbox or draft folder. Using this method, users must also browse through the menu to reach outbox/draft folder and then enter the number before sending message. Another method utilizes templates, but users must still browse through the menu to reach the message application and then insert template and the phone number before sending.

In all cases, considerable inconvenience is borne by the user, compounded when the message is frequently used, as for regularly updated information.

In conventional methods, users must browse through the menu list to reach either a composition option and enter text or outbox/draft option to select prewritten text and then insert the number before sending message.

Thus a need exists for a mobile device and a method to send message efficiently.

### BRIEF SUMMARY OF THE INVENTION

A detailed description is given in the following embodiments with reference to the accompanying drawings.

According to the invention, a method of sending messages is disclosed, comprising providing a shortcut with a corresponding message and recipient address, receiving a shortcut entry, determining whether the shortcut entry matches the shortcut, and sending the corresponding message to the corresponding recipient address when the shortcut entry matches the shortcut.

According to another embodiment of the invention, a computer-readable medium is disclosed, having stored thereon sequences of instructions, which, when executed by a microprocessor, causes the microprocessor to provide a shortcut with a corresponding message and recipient address, receive a shortcut entry, determine whether the shortcut entry matches the shortcut, and transmit the corresponding message to the corresponding recipient address when the shortcut entry matches the shortcut.

### BRIEF DESCRIPTION OF THE DRAWINGS

The invention can be more fully understood by reading the subsequent detailed description and examples with references made to the accompanying drawings, wherein:

FIG. 1 is a block diagram of an exemplary mobile apparatus performing message service according to the invention.

FIG. 2 is a flowchart of an exemplary message service method according to the invention.

FIG. 3 is a flowchart of an exemplary method for creating a message shortcut incorporated in FIG. 2.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

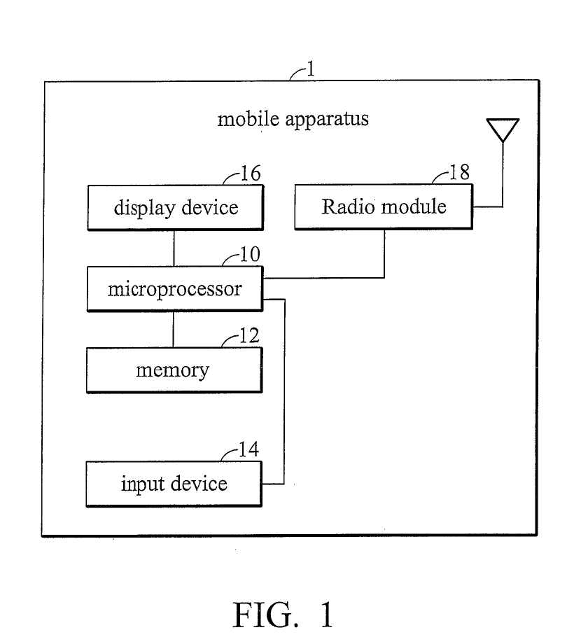

FIG. 1 is a block diagram of an exemplary mobile apparatus performing short message service according to the invention, comprising microprocessor 10, memory 12, input device 14, display device 16, and radio module 18. Microprocessor 10 is coupled to memory 12, input device 14, display device 16, and radio module 18.

Memory 12 is non-volatile memory, such as NVRAM or Flash memory, storing a list of shortcuts with corresponding text and/or multimedia messages and recipient addresses. The list of shortcuts, corresponding text and/or multimedia messages and recipient addresses may be stored in a lookup table. The messages may be SMS (Short Message Service) messages. Memory 12 may also store MMS (Multimedia Message Service) messages corresponding to the shortcut. The recipient address may be a phone number or an email address. Input device 14 includes a plurality of number and character information keys, and a plurality of function keys for selecting from a variety of functions. Input device 14 may be keypad or a touch panel, receiving a shortcut entry such that microprocessor 10 can determine the corresponding text and/or multimedia messages and recipient addresses. Display device 16 may be an LCD or touch panel to display a program menu including a shortcut menu thereon. Radio module 18 includes a transmitter and a receiver to transmit and receive the text and/or multimedia messages via an air protocol such as AMPS, CDMA, GSM, TDMA, or equivalent radio frequency or satellite communication protocols. Radio module 18 is attached to an antenna for data transmission.

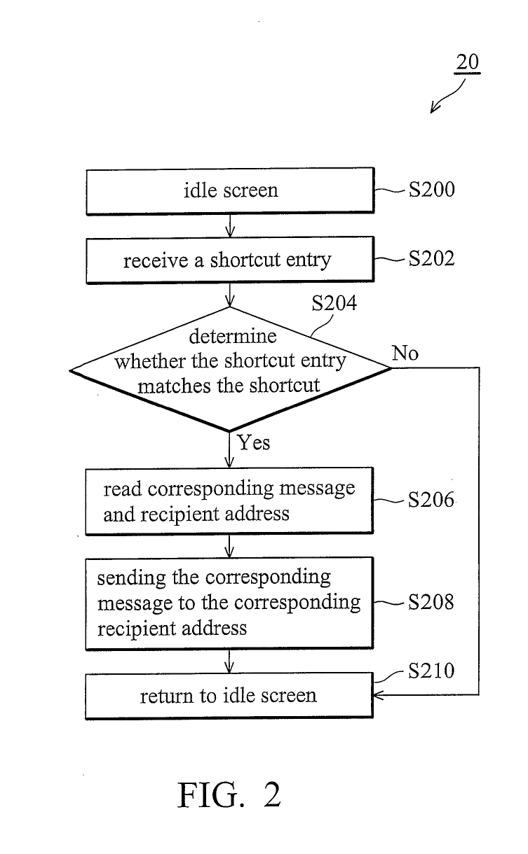

FIG. 2 is a flowchart of an exemplary quick message service method according to the invention, incorporating the mobile apparatus in FIG. 1. The method may be implemented by means of computer instructions that are stored in a computer-readable medium in the microcomputer 10.

In step S200, the mobile apparatus is initialized and display device 16 displays an idle screen. Upon initialization, the mobile apparatus provide a list of shortcuts with corresponding text and/or multimedia messages and recipient addresses in memory 12. The list of shortcuts and correspondences may be implemented by a lookup table.

Next, the mobile apparatus receives a shortcut entry entered by a user via input device 14 (S202), and stores the shortcut entry to memory 12. The shortcut entry may be a set of two characters starting with a ‘*’ (asterisk) key and followed by a digit key. The second key should be Long Pressed. In the disclosure, the first character is always a ‘*’ (asterisk) key and the second character can be any user defined digit key. The ‘*’ (asterisk) key is reserved as first key, so that Quick MESSAGE shortcut does not interfere with conventional functionality such as speed dial. However, the first character may alternatively be a ‘#’ (hash), ‘$’ (dollar), ‘&’ (ampersand), or any ANSI character, and those in the art can modify quick message method 2 where appropriate.

In step S204, microprocessor 10 determines whether the shortcut entry matches the shortcut. Microprocessor 10 reads the buffered shortcut entry from memory 12, searches through the list of shortcuts in memory 12 to find a match, goes to step S206 if a match is found, and to step S210 otherwise.

In step S206, microprocessor 10 looks up the corresponding text and/or multimedia messages and recipient address from memory 12 upon finding a match for the shortcut to the shortcut entry, and sends the corresponding text and/or multimedia message to the corresponding recipient address in step S208. Microprocessor 10 may send the corresponding text and/or multimedia message in the foreground after user confirmation, or in the background silently without user confirmation. The text and/or multimedia message may be sent using Message framework. Memory 12 may also store MMS messages corresponding to the shortcut, so that microprocessor 10 may send the MMS messages accordingly.

In step S210, the idle screen resumes and the next shortcut entry is sought.

While, here, two-character shortcuts are utilized, multiple character shortcuts may also be used, those skilled in the art can make modification to the method where appropriate according to the principle of the invention. The disclosed message method provides a more efficient and straightforward method for sending out repetitive text or multimedia messages on the existing SMS and MMS network.

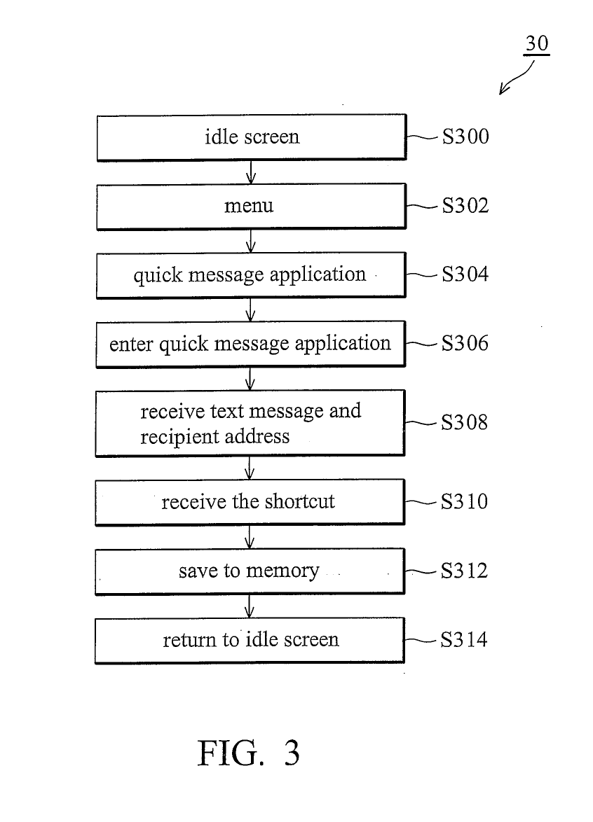

FIG. 3 is a flowchart of an exemplary method for creating a message shortcut incorporated in FIG. 2. The method may be implemented by means of computer instructions that are stored in a computer-readable medium in the microcomputer 10.

In step S300, the mobile apparatus is initialized and display device 16 displays an idle screen so that the user can create a predefined shortcut for the quick message method in FIG. 2.

Next in step S302, the user enters menu program to create a shortcut, browse a list of applications including the quick message application (S304), and selects the quick message application (S306). The mobile apparatus then receives the text and/or multimedia messages and the recipient address entered by user with keypads or soft keys (S308), and the shortcut corresponding thereto (S310). The mobile apparatus buffers both the shortcut and the corresponding text and/or multimedia messages and recipient address in memory 14 (S312), and associates both such that the user can exercise the quick message method in FIG. 2 by entering a predefined shortcut entry. In step S314, the idle screen resumes, ready for sending a quick message disclosed in FIG. 2.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method of sending a message by a communication device, comprising:
providing a shortcut with a corresponding message and a recipient address;
receiving a shortcut entry;
determining whether the shortcut entry matches the shortcut; and
sending the corresponding message to the corresponding recipient address when the shortcut entry matches the shortcut.

2. The method of claim 1, further comprising:
storing the shortcut in a memory of the communication device.

3. The method of claim 1, wherein the message comprises text and/or multimedia data.

4. The method of claim 1, further comprising:
transmitting the corresponding message to the corresponding recipient address in a background program.

5. The method of claim 1, wherein the recipient address is a phone number.

6. The method of claim 1, wherein the shortcut comprises a number of at least two-digits.

7. The method of claim 1, further comprising:
inputting the shortcut by a soft key or keypad of the communication device.

8. The method of claim 1, wherein the message is a short message conformed with an SMS and MMS protocol.

9. A computer-readable medium having stored thereon sequences of instructions, the sequences of instructions including instructions which, when executed by a microprocessor, cause the microprocessor to:
provide a shortcut with a corresponding message and a recipient address;
receive a shortcut entry;
determine whether the shortcut entry matches the shortcut; and
transmit the corresponding message to the corresponding recipient address when the shortcut entry matches the shortcut.

10. The computer-readable medium of claim 9, wherein the instructions further cause the microprocessor to:
store the shortcut in a memory of the communication device.

11. The computer-readable medium of claim 9, wherein the message comprises text and/or multimedia data

12. The computer-readable medium of claim 9, wherein the instructions further cause the microprocessor to:
transmit the corresponding message to the corresponding recipient address in a background program.

13. The computer-readable medium of claim 9, wherein the recipient address is a phone number.

14. The computer-readable medium of claim 9, wherein the shortcut comprises a number of at least two digits.

15. The computer-readable medium of claim 9, wherein the instructions further cause the microprocessor to:
input the shortcut by a soft key or keypad of the communication device.

16. The computer-readable medium of claim 9, wherein the message is a short message conformed with an SMS and MMS protocol.
